(19) United States
(12) Patent Application Publication
(10) Pub. No.: US 2005/0075094 A1
(43) Pub. Date: Apr. 7, 2005

(54) Messaging system

(76) Inventor: Nandan Vinayakrao Kundetkar, Singapore (SG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/498,854

(22) PCT Filed: Dec. 14, 2002
(86) PCT No.: PCT/SG02/00290

(30) Foreign Application Priority Data
Dec. 14, 2001 (SG) 0107921-9

(51) Int. Cl. H04Q 7/20

(52) U.S. Cl. 455/412.2; 455/412.1

(57) ABSTRACT

A messaging system wherein upon a message being received at a receiver's machine, the message is displayed on a screen of the receiver's machine. The receiver's machine is given a unique machine identity, and each user of the receiver's machine is given a unique user's identity. For each messaging event occuring, a date and time of that messaging record is recorded.

### FIELD OF INVENTION

This invention relates to a messaging system and refers particularly, though not exclusively, to a messaging system for delivery of messages over a network.

### DEFINITIONS

Throughout this specification reference to a network is to include all forms of telecommunications networks including those over cable, fibre optic cables, wireless, satellites, and direct broadcast (as in television and radio). This includes local area networks, wide area networks, the Internet, and the World Wide Web.

### BACKGROUND TO THE INVENTION

Messaging over networks such as the Internet is a relatively recent phenomenon—email is now only 30 years old. To receive a message sent over a network the receiver must have an email account, as well as an appropriate application such as, for example, Outlook Express or Lotus Notes. A connection to the network, normally by use of a modem, is also required. The receiver's machine must be ON, the application opened, the modem ON, and all account fees paid. The receiver then has to open their mailbox in box, select the message, and open it. This requires several steps. In some applications, if another application is in use, a toolbar icon will “flash”, change colour, or otherwise indicate, if there is a new message. But this is provided the messaging application has been opened. To retrieve the message can therefore involve the receiver in performing many procedural steps.

Certain cable television stations, as well as certain web sites, use a small strip display, usually at the lower portion of the display screen, to display messages. These messages are normally headlines of newsworthy events, stock prices, and so forth. All are solely text-based, and all are usually “pushed” onto the user's machine for display—it is there whether or not the user desires it. Also, they are fully broadcast messages and all can see all messages. They cannot be tailored at, directed to, and seen only by, a select group of users, or individual users. They cannot combine other forms of display such as graphics, animation, motion pictures, audio, and so forth. Furthermore, they are within a single, defined space that is a dedicated zone for messages, and is partitioned from the remainder of the screen.

Furthermore, there is no automatic tracking of the sending and/or receiving of messages so a sender can never prove receipt, unless an acknowledgement of receipt is requested at the time of sending.

It is therefore the principal object of the present invention to provide a messaging system that is easier to use at the receiver's end.

A second object is to provide a messaging system that includes the ability to track and record details of transmission and receipt of messages.

Another object is to provide a messaging system that allows multiple users at the one account and/or machine.

A further object is to provide a messaging system that allows messages to be broadcast to several recipients based on known profile data of the recipients

A further object is to provide a continuous or intermittent messaging display system that can display in a strip display zone all forms of message including graphics, animation, audio, motion pictures, and so forth.

### SUMMARY OF THE INVENTION

With the above and other objects in mind the present invention provides a messaging system wherein upon a message being received at a receiver's machine, the message is displayed on at least a part of a screen of the receiver's machine.

The message may be displayed in one or more of a number of ways, including (but not limited to):
(a) pop-up format;
(b) minimized format;
(c) icon-form;
(d) in a zone forming part only of the screen and having continuous or intermittent display of messages. The zone may or may not be partitioned from the remainder of the screen. If partitioned, the partitioning may be temporary, or permanent; or
(e) a full screen over any other application on the receiver's machine.

The nature, area, duration, time of commencement of display, or zone of the display, of the message may be determined or set by one or more of:
(a) the content of the message;
(b) the nature of the message (text, graphics, animation, motion picture, audio, and so forth);
(c) the sender;
(d) the server; and
(e) the receiver.

The message may be displayed without user activation being required or, alternatively, user activation may be required. The user activation may be a single click. The activation may be to enlarge the message to full or partial screen display or to another display format described above.

The receiver's machine may be given a unique machine identity, and each user of the receiver's machine may be given a unique user identity. The unique user identity may be linked to a particular machine so that an individual user can use the one unique user identity only with a particular machine. A user may have more that one machine (home, holiday house, work, and so forth) and therefore may have a separate unique identity for each machine. The unique machine identity may be created at any suitable time, including during machine manufacture or during initialization when installing the machine. The unique user identity may be created when the user first registers and may be set by the server and/or the user. All unique identities may be alpha, numeric, or alphanumeric and may be in multi-bit form.

From time to time the receiver's machine may send its unique machine identity to a remote server. Upon receiving the unique machine identity, the remote server may search a database for messages for the receiver's machine, the search being conducted using the unique machine identity, recover any messages for the receiver's machine that are not user-specific, and send the messages to the receiver's machine. The first sending of the unique machine identity may be when first starting the receiver's machine for a use session and, preferably, after log on by the user. Further sendings may be from time-to-time, and may be at preset, regular time intervals. The time intervals may be able to be varied by the user and/or the receiver's machine and/or the server.

From time-to-time the unique user's identity may be sent to the remote server. Upon receiving the unique user's identity the remote server may search the database for messages for the user, the search being conducted using the unique user's identity, recover any messages for the user, and send the messages to the receiver's machine. The sending of the unique user's identity may be when first starting the receiver's machine for a use session and, preferably, after the user has logged on. It may also be for each user when each user logs on.

In another form, the present invention provides a messaging system wherein a receiver's machine given a unique machine identity, and each user of the receiver's machine is given a unique user's identity.

From time to time the receiver's machine may send its unique machine identity to a remote server. Upon receiving the unique machine identity, the remote server may search a database for messages for the receiver's machine, the search being conducted using the unique machine identity, recover any messages for the receiver's machine that are not user-specific, and send the messages to the receiver's machine. The sending of the unique machine identity may be when first booting for a use session and, preferably, after log on by the user.

From time-to-time the unique user's identity may be sent to a remote server. Upon receiving the unique user's identity the remote server may search a database for messages for the user, the search being conducted using the unique user's identity, recover any messages for the user, and send the messages to the receiver's machine. The sending of the unique user's identity may be when first booting for a use session and, preferably, after the user has logged on. It may also be for each user when each user logs on.

Upon the message being received at a receiver's machine, the message is displayed on a screen of the receiver's machine. For the user to view the message, user activation may be required. The user activation may be a single click.

The display may be in a zone forming part of the screen. The zone may be in a strip form at a peripheral edge of the screen. The peripheral edge may be at least a part of the lower-most portion of the screen. The display in the zone may be a continuous display of messages received. The messages may contain one or more of text, graphics, animation, motion pictures and audio.

Upon a messaging event occurring, a date and time of that messaging event may be recorded. The messaging event may include one or more of: receiving a message, sending a message, retrieving a message, receiver's machine log in, user log in, user viewing a message.

The messaging system may include the recording of profile data of each user, the profile data date being stored on a database, the profile data including at least one characteristic data, broadcast messages being able to be sent to a plurality of receiver's machines for those users having a common characteristic data.

The at least one characteristic data may include one or more of: age, race, religion, sex, citizenship, residential status, occupation, language, location of residence, location of work, employer, educational and other qualifications, interests, hobbies and membership.

In a final form, the present invention also provides a system for messaging, wherein a message is received by a server for transmission to a receiver's machine, the server storing the message by reference to a unique machine identity of the receiver's machine and, if relevant, a unique user identity for a user of the receiver's machine; and, upon receiving from the receiver's machine the unique machine identity and, if relevant, the unique user identity, retrieving the message and sending it to the user's machine.

The present invention also includes a computer usable medium comprising a computer program code that is configured to cause a processor to execute one or ore of the steps as mentioned above; as well as apparatus including one or more computer means for performing corresponding one or more functions as described above.

### DESCRIPTION OF THE DRAWINGS

In order that the invention may be fully understood and readily be put into practical effect, there shall now be described by way of non-limitative example only a preferred embodiment of the present invention, the description being with reference to the accompanying illustrative drawings in which:

FIG. 1 is an illustration of the system architecture;

FIG. 2 is a flow chart of the overall system;

FIG. 3 is a flow chart of the overall system including a preferred reporting function;

FIG. 4 is a diagram showing a message distribution system; and

FIG. 5 is an illustration of the use of messaging according to the present invention for providing the results of a search.

### DESCRIPTION OF PREFERRED EMBODIMENT

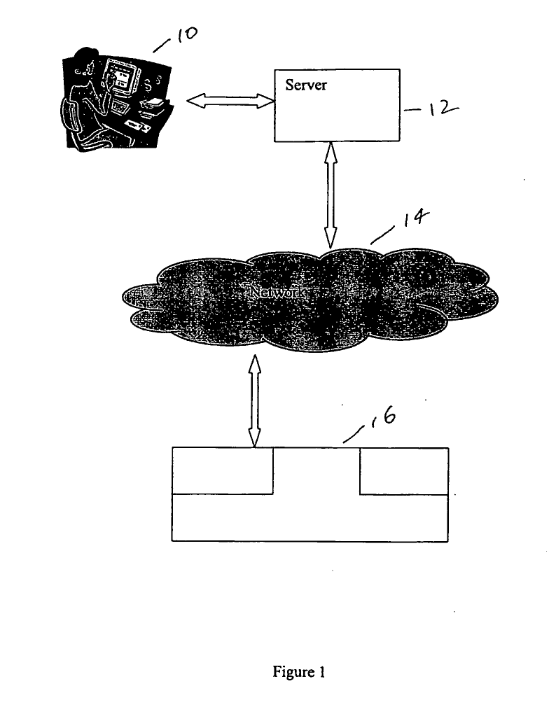

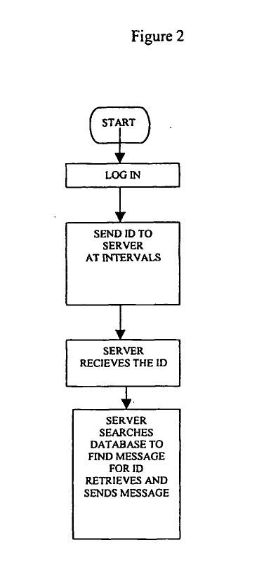

To refer to FIG. 1, with the messaging system of the present invention there is a message sender machine 10, a server 12, a telecommunications network 14 such as the Internet, and a receiver's machine 16. When a message created by sender machine 10 and intended for one or more users of receiver's machine 16 is delivered to the server 12 by any suitable means, it is stored in server 12 until the receiver's machine 16 logs on to server 12. This is shown in FIG. 2. When a user logs in, they may log in to their machine 16 and/or to the server 12.

When the receiver's machine 16 logs on to server 12, which may automatically happen when the receiver's machine 6 is switched ON at any time, the receiver's machine's 16 unique identity is sent to the server 12. Each person who may use machine 16 is required to have a user's identity and that is then sent to the server 12 after the user enters it into receiver's machine 16 at log on. The details of the unique user's identity may be held in the machine 16 and/or the server 12. The receiver's machine 16 identity may be sent to the server 12 at the same time as that of the user. When first initializing receiver's machine 16, full details of all potential users are entered into a users database controlled by, and forming part of server 12. Unique user identities are created for each user. The unique user identities may be set by the server and/or the user. All unique identities may be alpha, alphanumeric, or numeric.

If there is any message directed at all users of receiver's machine 16, or a general message, it will be retrieved by the server 12 after receiving the receiver's machine's 16 identity. This is achieved by server 12 searching through its database for messages intended for the receiver's inactive 16, based on that machines identity. It is then sent to the receiver's machine 16 by the server 12, and in consequence is received at receiver's machine 16.

If there is a message of server 12 for a particular user of receiver's machine 16, the server 12 waits until the particular user's identity is sent to it by the receiver's machine 16. Upon receiving the user's identity, the server 12 searches the database for any messages for that user's identity, retrieves those messages, and sends them to the receiver's machine 16, and the messages are in consequence received by the receiver's machine 16.

Upon a message being received by receiver's machine 16, a number of options are available for the nature of the display of the message. The display may be one or more of the following:
(a) the message is instantly displayed in full over, and is given priority over, any other application that the user is running;
(b) the message is displayed in a pop-up, minimized, or icon-form in a selected or predetermined area of a toolbar of the GUI on the receiver's machine 16;
(c) the message is displayed in a zone forming part only of the screen and having continuous or intermittent display of messages. The zone may or may not be partitioned from the remainder of the screen. If partitioned, the partitioning may be temporary, or permanent; or
(d) the message is displayed in pop-up, minimized, or icon-form in the main display area of the GUI on the receiver's machine 16, the display location being at random or in a pre-selected location.

The nature, area, duration, time of commencement of display, or zone of the display, of the message may be determined or set by one or more of:
(f) the content of the message;
(g) the nature of the message (text, graphics, animation, motion picture, audio, and so forth);
(h) the sender;
(i) the server; and
(j) the receiver.

For (b) and (d), the user can select the pop-up, compacted, or icon and, with one click, the message will be displayed as in (a) or (c). It is preferred that the message be displayed using an application that enables the message to be displayed in full whether it is one or more of text, graphics, tables, photographs, pictures, audio, motion picture, and so forth. This means only a single application is required to be able to display all presently known forms of message.

The unique identity for the receiver's machine and/or each user thereof may be in the format known as Media Access Control (“MAC”) address in accordance with IEEE802 standards. In addition, or alternatively, it may be a unique, created identity.

Furthermore, the receiver's machine 16 operates on a pull or poll basis so that any messages are only sent to it by server 12 after the receiver's machine 16 sends its identity (and any logged-on user's identity) to the server 12. Upon the server 12 receiving those identities, it searches its databases for any messages for either, or both, under those identities. Once the server 12 has searched the database for messages and sent them to the receiver's machine, it will not conduct a further search until the receiver's machine 16 again sends its identity, and the identities of any logged-on user, to server 12. This may be at regular, fixed intervals. The intervals may able to be altered by a user of receiver's machine and/or the server.

As each user of receiver's machine has their own identity, and as that identity must be entered at log in, the profile data of all users are stored in server 12. These may include one or more of: age, sex, race, religion, occupation, credit cards held (but preferably not the numbers in other details of any such cards), memberships, interests, hobbies, location and style of residence, location of work, employer, languages spoken, educational and other qualifications, motor vehicles owned/driven, and so forth. In this way, broadcast messages can be sent targeting groups having common profile data characteristics. These may include important messages, not just advertising or promotion. For example, messages to members of the armed forces, emergency services, special response groups, and so forth, may be sent. These can now be sent to only those individuals who are needed to be contacted.

Individuals may be grouped according to one or more characteristics of their profile data. This may be at the general level and/or at the level of the user's of a single machine. Therefore, a message may be created for delivery to one or members of one or more groups by reference to the group identity, the members of that group and their identity being stored in the server 12. If desired, the message can be to a restricted sub-group of members of one or more groups based on a characteristic of the profile data of the members of the one or more groups.

In addition, the messages may be advertising targeted to those users who have certain, defined, common characteristics. The advertising may be to all receivers' machines, and/or to all users.

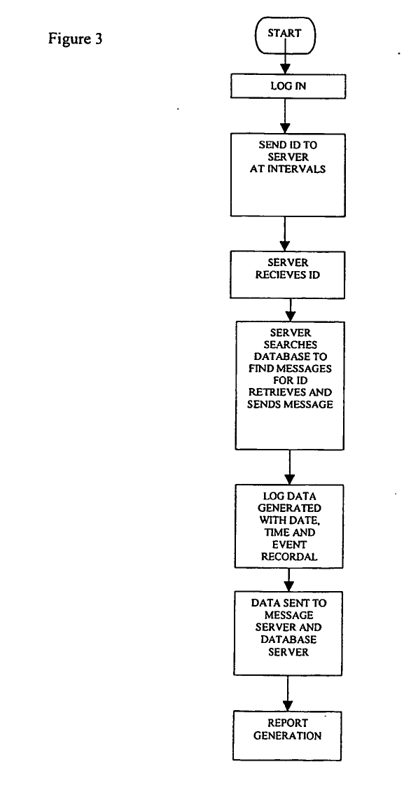

To keep track of messages, the preferred system of FIG. 3 is used. This is the same as that of FIG. 2 but with three extra steps. Here, the server 12 records data on each event by recording the date and time for each event. The data is sent to the message server 12 and its database server. The data can be presented in reports, which may be by individual, profile data groups, by one or more common characteristics, by percentages, or in any appropriate form. The events may be one or more of: the receipt of a message by the server, receiver machine log in, user log in, sending message to user, and user viewing message. Reports may include information on users who haven't logged in and/or haven't received messages. The timing or sequencing of the steps may be varied, if desired. For example, the second and third last steps may be reversed in order. The determination of the time and date may be at the server 12, or at each machine 16. Although messages travel at exceedingly high speeds, the time zone differences and date differences around the world may require both to be recorded.

By using a pull or poll mechanism firewall security systems are unaffected by the use of the system of the present invention provided the IP address of the server is not blocked by the service provider of any user.

The messages sent and displayed may be of any form, style or content, and may include alert messages. They may be diverted to SMS, or other systems, if desired. Messages may be programmed to be displayed and/or sent at a particular time an/or date so that, for example, birthday greetings can be prepared in advance but only sent on the receiver's birthday, anniversary, and so forth. Messages may be given a priority level so that they may interrupt another application if at a high priority level. Peer-to-peer messaging is possible, preferably using a Web interface. In this way one user can send a message to another user, the message passing to server 12 as is described above, and being retrieved by the other user as is described above.

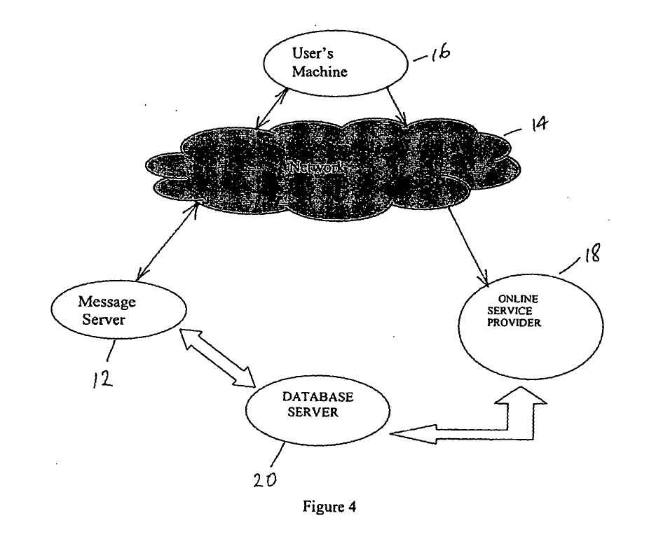

As shown in FIG. 4, the receiver's machine 16 may receive broadcast or alert messages from server 12 that have originated elsewhere. Here, an on-line service provider 18 receives an instruction from receiver's machine 16 to provide a message upon a particular event happening. When that event happens, the on-line service provider 18 send the message (normally, an alert) to a database server 20. Upon the receiver's machine 16 logging on, server 20 is notified of the log on by server 12 due to an alert notification having been earlier sent to server 12 by server 20 sends the message to message server 12. The message is then sent to receiver's machine 16.

The event may be any suitable event such as, for example, a change in a stock price, a person arriving in an office, or otherwise. Parameters for the event may be set by the user of receiver's machine 16.

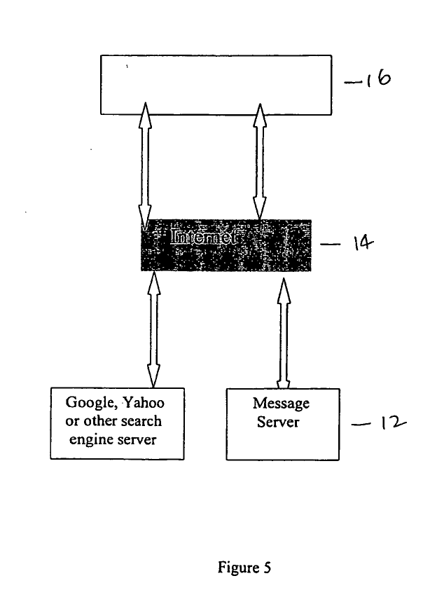

The present invention also provides a searching function as is described in our co-pending Singapore patent application filed contemporaneously herewith and titled “System, Method and Apparatus for Multimedia Display”, the contents of which are hereby incorporated by reference. This is briefly illustrated in FIG. 5. Upon the user requesting a search function at a web site, the search is conducted. The server 12 also conducts a search of all of its databases. The result of the search conducted by server 12 is the made available to the requesting user in the form of a message, which is “sent” to the receiver at the receiver's machine in accordance with the delivery system described above. This means the user doesn't have to go to a web site to receive the results of the search—it is sent as a message. The result of the search conducted by the external search engine can be obtained in the usual manner for that search engine. Alternatively, it may be notified to the server. The server can then deal with it in accordance with the system described above.

The present invention also provides a computer usable medium comprising a computer program code that is configured to cause a processor to execute one or more of the functions described above.

Furthermore, the present invention includes apparatus that includes one or more computer means for performing corresponding one or more functions as described above.

Whilst there has been described in the foregoing description a preferred embodiment of the present invention, it will be understood by those skilled in the technology that many variations or modifications in details of operations, architecture and methodology of the present invention may be made without departing from the present invention as claimed in the appended claims.

1. A messaging system with a user of each receiver machine being given a unique user identity, each receiver machine being given a unique machine identity, wherein a profile data of each user is recorded and stored on a database, the profile data including at least one characteristic data, and wherein broadcast messages are able to be sent to a plurality of users having a common characteristic data and upon a message being received at a receiver's machine, the message is able to be displayed on a screen of the receiver's machine.

2. A messaging system as claimed in claim 1, wherein the at least one characteristic data includes one or more selected from the group consisting of: age, race, religion, citizenship, residential status, sex, occupation, languages spoken, location of residence, type of residence, educational or other qualifications held, location of work, employer, interests, credit cards held, hobbies, and memberships.

3. A messaging system as claimed in claim 1, wherein the message is displayed in pop-up format.

4. A messaging system as claimed claim 1, wherein the message is displayed in minimized format.

5. A messaging system as claimed in claim 1, wherein the message is displayed in icon-form.

6. A messaging system as claimed in claim 1, wherein the message is displayed in a zone forming part only of the screen.

7. A messaging system as claimed in claim 6, wherein the zone is not partitioned from a remainder of the screen.

8. A messaging system as claimed in claim 6, wherein the zone is partitioned from a remainder of the screen.

9. A messaging system as claimed in claim 8, wherein the partitioning is only for as long as the message is displayed.

10. A messaging system as claimed in claim 1, wherein the message is displayed on a full screen over any other application on the receiver's machine.

11. A messaging system as claimed in claim 1, wherein the message is displayed according to one or more factors selected from the group consisting of: area of display, location of display, time of commencement of display, duration of display, and zone of the display

12. A messaging system as claimed in claim 1, wherein the display is determined by one or more selected from the group consisting of: a sender, a server, the receiver, the message content, the message nature.

13. A messaging system as claimed in claim 1, wherein the message is displayed without user activation being required.

14. A messaging system as claimed in claim 1, wherein for the user to view the message, user activation is required.

15. A messaging system as claimed in claim 14, wherein user activation is a single click.

16. A messaging system as claimed in claim 1, wherein from time to time the receiver's machine sends its unique machine identity to a remote server.

17. A messaging system as claimed in claim 16, wherein upon receiving the unique machine identity, the remote server searches a database for messages for the receiver's machine, the search being conducted using the unique machine identity, recovers any messages for the receiver's machine that are not user-specific, and sends these messages to the receiver's machine.

18. A messaging system as claimed in claim 1, wherein from time-to-time the unique user's identity is sent to a remote server.

19. A messaging system as claimed in claim 18, wherein upon receiving the unique user's identity the remote server searches a database for messages for the user, the search being conducted using user's identity, recovers any messages for the user, and sends those messages to the receiver's machine.

20. A computer usable medium comprising a computer program code that is configured to cause a processor to execute one or one of the steps as defined in claim 1.

21. Apparatus including one or more computer means for performing corresponding one or more functions as defined in claim 1.

22-38. (Cancelled)
